(19) United States
(12) Patent Application Publication
(10) Pub. No.: US 2014/0164905 A1
(43) Pub. Date: Jun. 12, 2014

(54) SYSTEM AND METHOD FOR DISPLAYING CONTENT ON MOBILE DEVICES

(71) Applicant: PARLANT TECHNOLOGY, INC., PROVO, UT (US)

(72) Inventors: Hassler Bruce, Mapleton, CA (US); Dallin Lauritzen, Orem, UT (US)

(73) Assignee: PARLANT TECHNOLOGY, INC., PROVO, UT (US)

(21) Appl. No.: 14/019,029

(22) Filed: Sep. 5, 2013

Related U.S. Application Data
(63) Continuation-in-part of application No. 13/709,293, filed on Dec. 10, 2012.

(51) Int. Cl. G06F 17/22

(52) U.S. Cl. CPC G06F 17/2247
USPC 715/234

(57) ABSTRACT

The various implementations of the present invention are provided as a computer-based system configured to transform website content for display on mobile devices. Standard website content is captured and transformed into a customized form and format that is mobile device friendly. The relevant content is copied and pasted into a pre-configured template that provides content suitable for mobile device browsers. The content transformation may be automated or performed with user intervention. The transformation may be accomplished in real time, as content is requested, or prior to the request. In either case, after transformation, the mobile device friendly content is stored on a webserver and may be updated on a periodic basis or “on demand” basis and made available for viewing at a later date.

### RELATED APPLICATIONS

The present application is a continuation in part of U.S. patent application Ser. No. 13/709,293 which application was filed on Dec. 10, 2012, which application is now pending and which application is incorporated herein by reference.

### BACKGROUND OF THE INVENTION

1. Technical Field

The present invention relates generally to the field of Internet communication and more specifically relates to systems and methods for delivery of website content to mobile devices.

2. Background Art

With the widespread adoption of the Internet, most schools, businesses, government agencies, and other organizations have developed one or more websites where they can share information with their customers, clients, and constituencies. The ability to use the Internet to communicate messages is generally viewed as a cost effective approach for sharing information for organizations with a limited budget. Additionally, the flexibility of posting information at a website and making it available in real time is also considered highly desirable.

While the use of websites to share information is undoubtedly a valuable tool, it is not without certain limitations. One of the most significant problems is the growth of mobile devices (e.g., smart phones, iPods, tablets, etc.) being used to access content at websites. Most mobile devices, while equipped with some type of browser functionality, do not have the capability to deliver the complete and robust variety and quantity of content typically displayed at many websites. When a mobile device user accesses these websites, the content is generally not optimized for the smaller screen and reduced functionality of the mobile device. This typically means that the mobile device user is faced with viewing content that is not well suited for display on a mobile device. This can lead to frustration since the content, as displayed on the screen of the mobile device, may be illegible or difficult to parse.

To counter this, many organizations have opted to create a “mobile device friendly” version of their website. This allows a mobile device user to access the website and view the content in a format that has been specifically optimized for viewing on a mobile device. While this is a viable approach, it also suffers from a number of problems. The most significant issue facing many organizations is a lack of resources (e.g., time, money, personnel, etc.) typically required to create and maintain two separate versions of the website. While having two versions of a website may be a good idea, it may be simply impractical for schools, non-profit organizations, charities, and other entities that are resource constrained.

With the advent of “responsive” website design, it is now possible to create and maintain a single website that will provide standard website content for desktop computer browsers and also provide website content that has been optimized for viewing on a mobile device. While this approach will obviate the need for creating and maintaining multiple websites for the same content, “legacy” websites cannot easily deploy this technology without extensive revision, which is often impossible due to resource constraints.

Therefore, many organizations are left with few viable options and their constituencies may face frustration as they try to access the information at various websites that have not been optimized for mobile devices. This, in turn, may hamper the effectiveness of the organization as they attempt to communicate with website visitors. Accordingly, without improvements in the current systems, procedures, and methods for the communication of web-based information to mobile devices, the ability to effectively and efficiently provide important information to their constituency via websites will continue to be sub-optimal.

### BRIEF SUMMARY OF THE INVENTION

The various implementations of the present invention are provided as a computer-based system configured to transform website content for display on mobile devices. Standard website content is captured and transformed into a customized form and format that is mobile device friendly. The relevant content is copied and pasted into a pre-configured template that provides content suitable for mobile device browsers. The content transformation may be automated or performed with user intervention. The transformation may be accomplished in real time, as content is requested, or prior to the request. In either case, after transformation, the mobile device friendly content is stored on a web server and may be updated on a periodic basis or “on demand” basis and made available for viewing at a later date. While useful for many environments, the most preferred embodiments of the present invention are adapted for use in an educational environment to provide school administrators, teachers, parents, and students with enhanced communication capabilities. Unless explicitly stated, the use of the conjunction “or” is the nonexclusive use of “or.” For example, “A or B” means “A, B, or both A and B.”

### BRIEF DESCRIPTION OF THE FIGURES

The preferred embodiments of the present invention will hereinafter be described in conjunction with the appended drawings, wherein like designations denote like elements, and:

FIG. 1 is a schematic diagram of a computer-based system for transforming website content for display on mobile devices in accordance with a preferred exemplary embodiment of the present invention;

FIG. 2 is a block diagram of a server (computer) used for transforming website content for display on mobile devices in accordance with a preferred exemplary embodiment of the present invention;

FIG. 3 is a block diagram illustrating the interactions with a computer-based system for transforming website content for display on mobile devices in accordance with a preferred exemplary embodiment of the present invention;

FIG. 4 is a block diagram of a template used in conjunction with a computer-based system for transforming website content for display on mobile devices in accordance with a preferred exemplary embodiment of the present invention;

FIG. 5 is a block diagram of a standard webpage used in conjunction with a computer-based system for transforming website content for display on mobile devices in accordance with a preferred exemplary embodiment of the present invention;

FIG. 6 is a flow chart of a method for transforming standard website content for display on mobile devices in accordance with a preferred exemplary embodiment of the present invention;

FIG. 7 is a schematic representation of a user interface for creating a template for generating mobilized website content to display on mobile devices in accordance with a preferred exemplary embodiment of the present invention;

FIG. 8 is a schematic representation of a user interface for accessing mobilized website content created for display on mobile devices in accordance with a preferred exemplary embodiment of the present invention; and

FIG. 9 is a schematic representation of a content source used to create mobilized website content created for display on mobile devices in accordance with a preferred exemplary embodiment of the present invention.

### DETAILED DESCRIPTION OF THE INVENTION

The various implementations of the present invention are provided as a computer-based system configured to transform website content for display on mobile devices. Standard website content is captured and transformed into a customized form and format that is mobile device friendly. The relevant content is copied and pasted into a pre-configured template that provides content suitable for mobile device browsers. The content transformation may be automated or performed with user intervention. The transformation may be accomplished in real time, as content is requested, or prior to the request. In either case, after transformation, the mobile device friendly content is stored on a web server and may be updated on a periodic basis or “on demand” basis and made available for viewing at a later date.

For purposes of this disclosure, “standard website” shall mean a website that contains content (e.g., text, graphics, etc.) that has not been optimized for display on a mobile device and “mobilized website” shall mean a website that contains content that has been transformed from a standard website where the content has been optimized for display on one or more mobile devices. The various preferred embodiments of the present invention provide for autonomous or user-driven transformation of standard website content to mobilized website content. By using the various preferred embodiments of the present invention, organizations can quickly and efficiently provide a mobilized website experience for their constituents.

Aspects of the present invention are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in or on a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Additionally, various preferred embodiments of the program product may be configured to: create and modify multiple databases; track, update and store data related to the optimized creation and delivery of mobilized web site content; configure and implement various display functions for a multitude of websites accessed by users of mobile web access devices; track and store information about various services and program features; prepare standard website content for display as mobilized website content for one or more end users; and provide one or more user interfaces for accomplishing all of these functions.

In this fashion, the appropriate entities (i.e., business owners, managers, administrators, teachers, parents, students, etc.) can utilize the program product to initiate and complete a wide variety of database-related applications for the provision of mobilized website content. Similarly, a program product in accordance with one or more preferred embodiments of the present invention can also be configured to perform substantially all of the steps depicted and described in conjunction with the figures below for implementing a mobilized website content transformation and delivery system as described herein.

While the present invention will be described in detail by using various examples of a typical school or educational environment, those skilled in the art will recognize that the equipment, processes, methods and techniques described herein have broad applicability to other environments and applications where quick and efficient access to optimized website content for mobile devices is desirable.

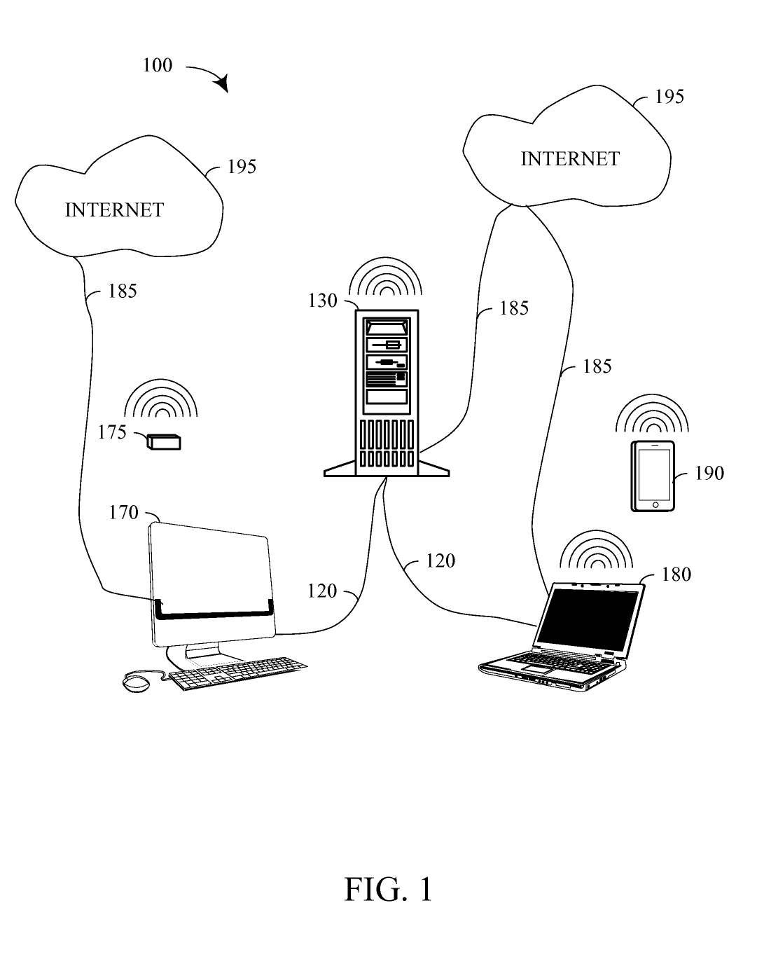

Referring now to FIG. 1, a computer-based system 100 for transforming website content for display on mobile devices in accordance with a preferred exemplary embodiment of the present invention comprises: a data server (computer) 130; at least one of a desktop computer 170 or a laptop computer 180; a wireless communication device 175; and a mobile communication device 190 (e.g., a smartphone or Personal Digital Assistant) all connected or coupled via a local area network 120 to the Internet 195 via an Internet connection 185.

Taken together, the components of computer-based system 100 provide a platform for quickly and efficiently transforming website content for display on mobile devices for a wide variety of individuals and groups of individuals who are constituents of an organization. Computer-based system 100 provides a mechanism for individuals and organizations to efficiently and effectively create a mobilized website experience for their constituents without the expense and time traditionally associated with building and maintaining multiple versions of their website.

In the most preferred embodiments of the present invention, computer-based system 100 is configured as a system that will be used to display mobilized website content for an educational community in a typical school environment. In this preferred embodiment, the group of users for computer-based system 100 will typically include administrators for individual schools as well as school board and school district officials, teachers, staff, community members, parents, and students.

Network 120 represents any suitable computer communication link or similar communication mechanism, including some combination of a hardwired connection, an internal or external bus, a connection for telephone access via a modem, standard co-axial cable lines, high-speed T1 line, radio, infrared or other wireless communication methodologies (e.g., “Bluetooth,” infrared (IR), etc.), private or proprietary local area networks (LANs) and wide area networks (WANs), as well as standard computer network communications over Internet 195 or an internal network (e.g. “intranet”) via a wired or wireless connection, or any other suitable connection between computers and computer components known to those skilled in the art, whether currently known or developed in the future. It should be noted that portions of network 120 might suitably include a dial-up phone connection, a broadcast cable transmission line, a Digital Subscriber Line (DSL), an ISDN line, or similar public utility-like access link.

In the most preferred embodiments of the present invention, at least a portion of network 120 comprises a standard Internet connection 185 between at least some of the components of computer-based system for providing optimized message creation and delivery 100 for providing access to additional network resources and other remote locations. Network 120 provides for communication between the various components of computer-based system 100 and allows for relevant information to be transmitted from device to device. In this fashion, a user of computer-based system 100 can quickly and easily gain access to the relevant data and information utilized to search, retrieve, and display mobilized website content from one or more standard websites as described in conjunction with the various preferred embodiments of the present invention.

In the most preferred embodiments of the present invention, network 120 is configured to provide relatively high-speed transmission of textual information, audio and video data and signals, and also comprises at least an Internet connection 185 for transmission of data captured by one or more computers 170 or 180.

In addition to the other components shown in FIG. 1, a wireless communication access device 175 may optionally be communicatively coupled to network 120 and represents any type of wireless communication mechanism that is known to those skilled in the art to provide for wireless communication between network 120 and the various devices associated with network 120, including desktop computer 170, laptop computer 180 and as well as mobile communication device 190. The most preferred embodiments of an acceptable wireless communication access device may comprise any type of wireless bridge, wireless router, or wi-fi “hotspot.”

Regardless of the specific components, physical nature, and topology, network 120 serves to logically and communicatively link the physical components of computer-based system 100, thereby enabling stable and consistent communication between the components. This is especially important because in many preferred embodiments of the present invention, data server 130, desktop computer 170, and laptop computer 180 may be geographically remote and/or physically separated from each other.

Data server 130 represents a relatively powerful computer system that is made available to desktop computer 170, laptop computer 180, and/or mobile communication device 190 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art.

Given the relative advances in the state-of-the-art computer systems available today, it is anticipated that functions of data server 130 may be provided by many standard, readily available data servers. This may also include the deployment of multiple inter-connected and redundant data servers 130 to enhance the availability and reliability of the functions provided by data server 130. Depending on the desired size and relative power required for data server 130, storage area network (SAN) technology may also be deployed in certain preferred embodiments of the present invention. Additionally, various biometric and identification verification devices for identifying users and controlling access as well as creating and verifying digital signatures (i.e., electronic signature processing) may also be included.

Desktop computer 170 may be any type of computer system known to those skilled in the art that is capable of being configured for use with computer-based system 100 as described herein. It should be noted that no specific operating system or hardware platform is excluded and it is anticipated that many different hardware and software platforms may be configured to create computer 170. As previously explained in conjunction with data server 130, various hardware components and software components (not shown this FIG.) known to those skilled in the art may be used in conjunction with computer 170. It should be noted that in the most preferred embodiments of the present invention, desktop computer 170 may be linked (via wired or wireless connection) to its own LAN or WAN and have access to one or more additional data servers (not shown this FIG.).

Similarly, laptop computer 180 may be any type of relatively lightweight portable computer system known to those skilled in the art that is capable of being configured for use with computer-based system 100 as described herein. This includes tablet computers (e.g., iPad®), pen-based computers and the like. Computer 180 may also be configured to allow the transmission and reception of audio signals, messages, communications, and various types of alerts via server 130 and network 120.

Additionally, netbooks, tablets, handheld and palmtop devices are also specifically included within the description of devices that may be deployed as a laptop computer 180. It should be noted that no specific operating system or hardware platform is excluded and it is anticipated that many different hardware and software platforms may be configured to create laptop computer 180. As previously explained in conjunction with data server 130, various hardware and software components (not shown this FIG.) known to those skilled in the art may be used in conjunction with laptop computer 180. It should also be noted that in the most preferred embodiments of the present invention, laptop computer 180 is linked to its own LAN or WAN and has access to one or more of its own data servers (not shown this FIG.).

In general, the communication between devices associated with data server 130 will be data associated with standard websites and, after transformation, mobilized websites. The users of desktop computer 170 and/or laptop computer 180 may be program administrators, managers, teachers, community members, parents and students who are seeking to create and provide access to information that will be optimized for display on mobile devices such as mobile communication device 190. Additionally, various related entities such as local and regional governments, commercial enterprises, municipalities, and their employers and agents may also have access to one or more databases located on data server 130 via desktop computer 170 and/or laptop computer 180.

It should be noted that while FIG. 1 shows only a single desktop computer 170 and a single laptop computer 180, it is anticipated that the most preferred embodiments of the present invention will comprise dozens or even hundreds of computers 170 and laptop computers 180. Each of these computers 170 and 180 will be configured to access data server 130 in an appropriately secure way so as to accomplish the specific objectives of the user of the desktop computer 170 or laptop computer 180.

For example, the service provider that controls the databases stored on data server 130 may utilize desktop computer 170 or laptop computer 180 or mobile communication device 190 to access data server 130 and access, create, update or otherwise modify the content at one or more standard websites for display on one or more mobile communication devices 190. An operator, located in a remote location, may use desktop computer 170 or laptop computer 180 to access data server 130 to retrieve information about the participants or persons and the various mobilized website content being created and delivered by the users of computer-based system 100.

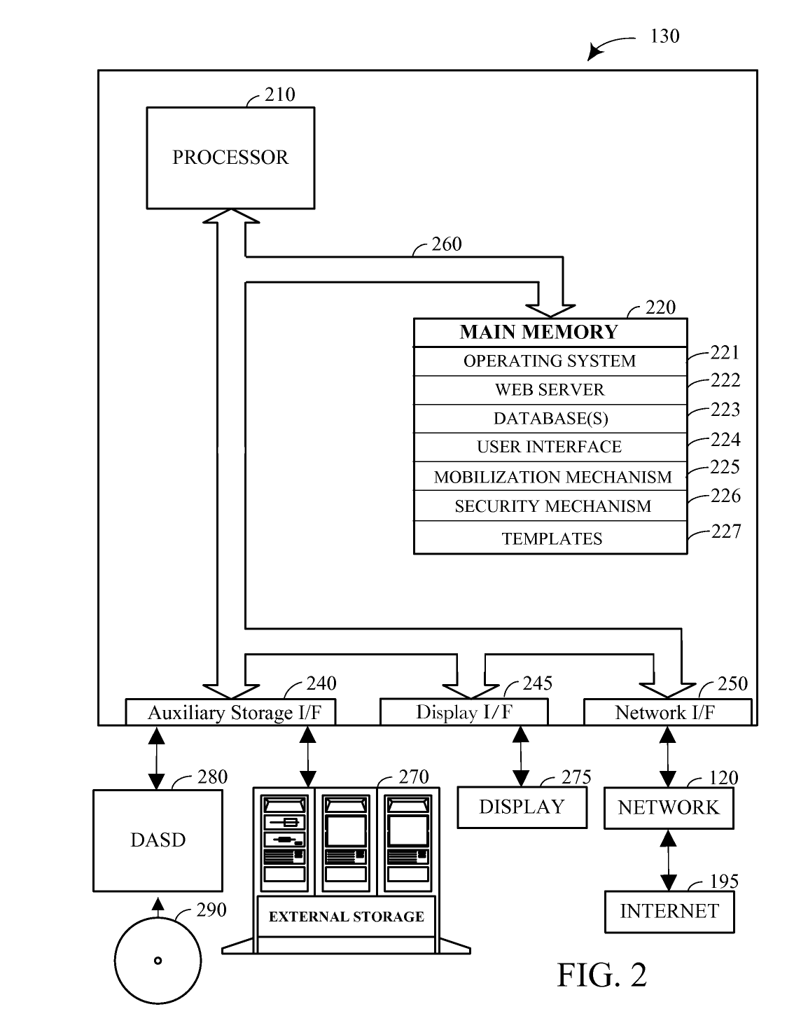

In the most preferred embodiments of the present invention, multiple desktop computers 170 and multiple laptop computers 180 will all be configured to communicate simultaneously with data server 130 and with each other via network 120. In addition, the most preferred embodiments of the present invention include a Software as a Service (SAAS) or Platform as a Service (PAAS) environment where data server 130 may be operated in a hosted operation. In this fashion, multiple desktop computers 170 and laptop computers 180 will have access to data server 130 and the databases stored thereon via a global computer network such as Internet 195. Data server 130 is further described below in conjunction with FIG. 2 below.

An optional printer and an optional fax machine (not shown this FIG.) may also be deployed for various hard copy data output requirements and may be considered to be any standard peripheral devices used for transmitting or outputting paper-based version of website content generated in conjunction with the operation of computer-based system 100 (e.g., reports, communications, statistical analyses, automated letters, etc.). Finally, it should be noted that the optional printer and the optional fax machine are merely representative of the many types of peripherals that may be utilized in conjunction with computer-based system 100. It is anticipated that other similar peripheral devices will be deployed in the various preferred embodiment of the present invention and no such device is excluded by its omission in FIG. 1.

Mobile communication device 190 is representative of any type of cellular device, wi-fi or Internet enabled mobile communication device that may be communicatively coupled to computer-based system 100. This includes, for example, personal digital assistants (“PDAs”), Windows® mobile phone devices, Android® OS devices, Palm® OS devices, Pocket PC® devices, the Apple® iPod Touch®, the Apple® iPhone® and other various types of smartphones and portable communication devices, including tablets. Those skilled in the art will recognize these various devices and others that are suitable for deployment as mobile communication device 190. While somewhat less powerful than computers 170 and 180, mobile communication device 190 may also be configured to wirelessly communicate with data server 130 via network 120 to send and receive communications and data to and from data server 130. Given the standard functionality for devices that may be deployed as mobile communication device 190, this communication capability be provided by a wireless Internet connection (e.g. “wi-fi” or “wi-max”) or a Bluetooth® connection as well as LTE and other cellular data communication networks.

Those skilled in the art will recognize that FIG. 1 depicts a fairly standard “client/server” type communication arrangement where data server 130 is considered to be a server and computers 170 and 180 and mobile device 190 are considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that needs to be transferred from a database to the user of computer-based system 100.

Referring now to FIG. 2, data server 130 of FIG. 1 in accordance with a preferred embodiment of the present invention represents one of many commercially available computer systems such as a Linux®-based computer system, an IBM® compatible computer system, or a Macintosh® computer system. However, those skilled in the art will appreciate that the methods and system of the present invention apply equally to any computer system, regardless of the specific operating system and regardless of whether the computer system is a more traditional “mainframe” computer, a complicated multi-user computing device or a single user device such as a personal computer or workstation.

Data server 130 suitably comprises at least one Central Processing Unit (CPU) or processor 210, an auxiliary storage interface 240, a display interface 245, and a network interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the more salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 is configured to execute one or more software programs contained within main memory 220. Although data server 130 depicted in FIG. 2 contains only a single main processor 210 and a single system bus 260, it should be understood that the present invention applies equally to computer systems having multiple processors and multiple system buses. Similarly, although system bus 260 of the preferred embodiment is a typical hardwired, multi-drop bus, any connection means that supports bi-directional communication in a computer-related environment could be used.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a non-volatile DVD or CD disk 290.

Display interface 245 is used to directly connect one or more displays 275 to data server 130. Displays 275, which may be non-intelligent displays (e.g., “dumb”) terminals or fully programmable workstations, are used to provide system administrators and users the ability to communicate with data server 130. Note, however, that while display interface 245 is provided to support communication with one or more displays 275, computer data server 130 does not necessarily require a display 275, because all needed interaction with users and other processes may occur via network 120. Additionally, in certain preferred embodiments, data server 130 may have an integrated display 275.

Network interface 250 is used to connect data server 130 to network 120 and computer-based system 100, including computer 170 and computer 180 of FIG. 1. Network interface 250 broadly represents any suitable way to interconnect electronic devices, regardless of whether the network comprises present day analog and/or digital techniques or via some networking mechanism of the future. Network interface 250 preferably includes a combination of hardware and software that allows communications on network 120.

Software provided in conjunction with network interface 250 preferably includes a communication manager that manages communication with other computer systems or other network devices via network 120 using a suitable network protocol. Many different network protocols can be used to implement a network. As used herein, protocols are a formal set of conventions governing the format and control of interaction among communication functional units. TCP/IP (Transmission Control Protocol/Internet Protocol) is just one example of a suitable network protocol that may be used by the communication manager contained within network interface 250.

It is important to note that while the present invention has been (and will continue to be) described in the context of a fully functional computer system with certain application software, those skilled in the art will appreciate that the various software mechanisms of the present invention are capable of being distributed as a program product in conjunction with an article of manufacture comprising software stored on a computer readable storage medium in a variety of forms, and that the various preferred embodiments of the present invention applies equally regardless of the particular type or storage medium used to actually carry out the distribution. Examples of computer readable storage media include: non-volatile and non-transitory recordable type media such as DVD and CD ROMS disks (e.g., disk 290), and transmission type media such as digital and analog communication links, including wireless communication links.

Main memory 220 suitably contains an operating system 221, a web server 222, one or more databases 223, a user interface 224, a mobilization mechanism 225, a security mechanism 226, and one or more templates 227. The term “memory” as used herein refers to any storage location in the virtual memory space of data server 130.

It should be understood that main memory 220 might not necessarily contain all parts of all components shown. For example, portions of operating system 221 may be loaded into an instruction cache (not shown) for processor 210 to execute, while other files may well be stored on magnetic or optical disk storage devices (not shown). In addition, although database 223 is shown to reside in the same memory location as operating system 221, it is to be understood that main memory 220 may consist of multiple disparate memory locations. It should also be noted that any and all of the individual software mechanisms or components shown in main memory 220 might be combined in various forms and distributed as a stand-alone program product. Finally, it should be noted that additional software components, not shown in this figure, might also be included.

Operating system 221 includes the software that is used to operate and control data server 130. In general, processor 210 typically executes operating system 221. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware (e.g., load balancers) and software systems. This configuration provides additional robustness for system uptime and reliability purposes. Regardless of the specific form of implementation, web server 222 provides access, including a user interface, to allow individuals and entities to interact with graphical user interface 224, including via network 120 of FIG. 1.

Database 223 is representative of any suitable database known to those skilled in the art. In the most preferred embodiments of the present invention, database 223 is a Structured Query Language (SQL) compatible database file capable of storing information relative to various items that may be of interest to the users of computer-based system 100 of FIG. 1. In the most preferred embodiments of the present invention, database 223 will comprise a plurality of information that may be useful to an organization or individual that wants to provide for efficient and effective creation of mobilized website content in conjunction with a preferred embodiment of computer-based system 100 of FIG. 1.

Graphical user interface 224 is a software component that provides the users of computer-based system 100 of FIG. 1 a means for interacting with the various components of computer-based system for transforming website content for display on mobile devices. In at least some of the most preferred embodiments of the present invention, graphical user interface 224 is a web browser based interface, accessible to the users of computer-based system 100 via any standard web browser from any computer that is connected to the Internet. Additional details on graphical user interface 224 are presented below.

Additionally, at least one preferred embodiment of the present invention comprises a graphical user interface deployed on a mobile communication device 190. In this embodiment, a graphical user interface may be offered via an “app” customized for mobile communication device 190 or via a web browser based interface, providing a connection to data server 130, allowing the user of mobile communication device 190 to access mobilization mechanism 225 and database 223 will be accessible and customizable via the graphical user interface provided in conjunction with mobile communication device 190.

In at least one preferred embodiment of the present invention, database 223 of FIG. 2 will typically include a plurality of database records containing information about multiple standard websites and the mobilized websites derived from the standard websites. This information may be provided to interested and authorized users of computer-based system 100 of FIG. 1 for purposes of accessing standard websites and to create mobilized websites.

Database 223 may also be used to store user data (e.g., user profiles and account information, website preferences, organization profiles, etc.) containing detailed information about each user or group of users, including user phone numbers, email addresses, permissions, home and work addresses, etc.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 might also be physically stored in a location other than main memory 220. For example, database 223 may be stored on external storage device 270 or DASD 280 and coupled to data server 130 via auxiliary storage OF 240. Additionally, while shown as a single database 223, those skilled in the art will recognize the database 223 may actually comprise a series of related databases, logically linked together. Depending on the specific application and design parameters, database 223 may take many different forms when implemented.

The most preferred embodiments of computer-based system 100 of FIG. 1 will include a mobilization mechanism 225 in main memory 220. Mobilization mechanism 225 will generally comprise a series of task oriented (e.g., website parsing, website content transformation, etc.) routines. Mobilization mechanism 225 is an automated programmable system that is capable of assisting users who access database 223 to create mobilized website content from standard website content.

In the most preferred embodiments of the present invention, mobilization mechanism 225 will be configured to extract a subset of the content displayed at standard websites and transform the subset of the content into mobilized website content suitable for display on mobile devices. Mobilization mechanism 225 may be configured to operate programmatically or with the assistance of one or more humans.

In at least one preferred embodiment of the present invention, mobilization mechanism 225 saves the mobilized content that has been generated from the standard website content in database 223. The mobilized content can be periodically updated and stored, allowing mobilization mechanism 225 to more quickly retrieve the mobilized website content from database 223 in the future so that if a subsequent request for display of the content is received, the previously mobilized website content can be simply retrieved from database 223 and displayed on the mobile device without the need of performing the transformation of the standard website content.

In addition, the most preferred embodiments of the present invention comprise security mechanism 226 for verifying access to the data and information contained in and transmitted to and from data server 130. Security mechanism 226 may be incorporated into operating system 221 and/or web server 222. Additionally, security mechanism 226 may also provide encryption capabilities for other components of computer-based system 100 of FIG. 1, thereby enhancing the robustness of computer-based system 100 of FIG. 1. Security mechanism 226 is most preferably configured to protect the integrity and security of the information transmitted via network 120 of FIG. 1.

Further, depending on the type and quantity of information stored in database 223 and accessed by graphical user interface 224, security mechanism 226 may provide different levels of security and/or encryption for different computer systems 170 and 180 of FIG. 1 and the information stored in database 223. In some preferred embodiments of the present invention, security mechanism 226 may be contained in or implemented in conjunction with certain hardware components (not shown this FIG.) such as hardware-based firewalls, switches, dongles, and the like.

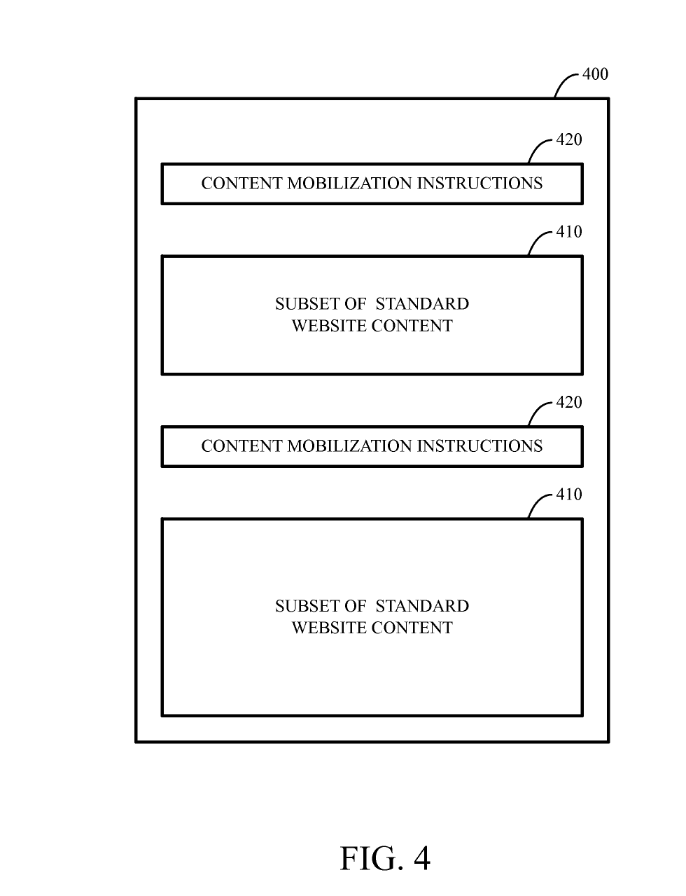

Templates 227 are typically user developed instructions that are used to control the process of transforming standard website content into mobilized website content, suitable for display on mobile device 190 of FIG. 1. Additional information about templates 227 is presented in conjunction with FIG. 4.

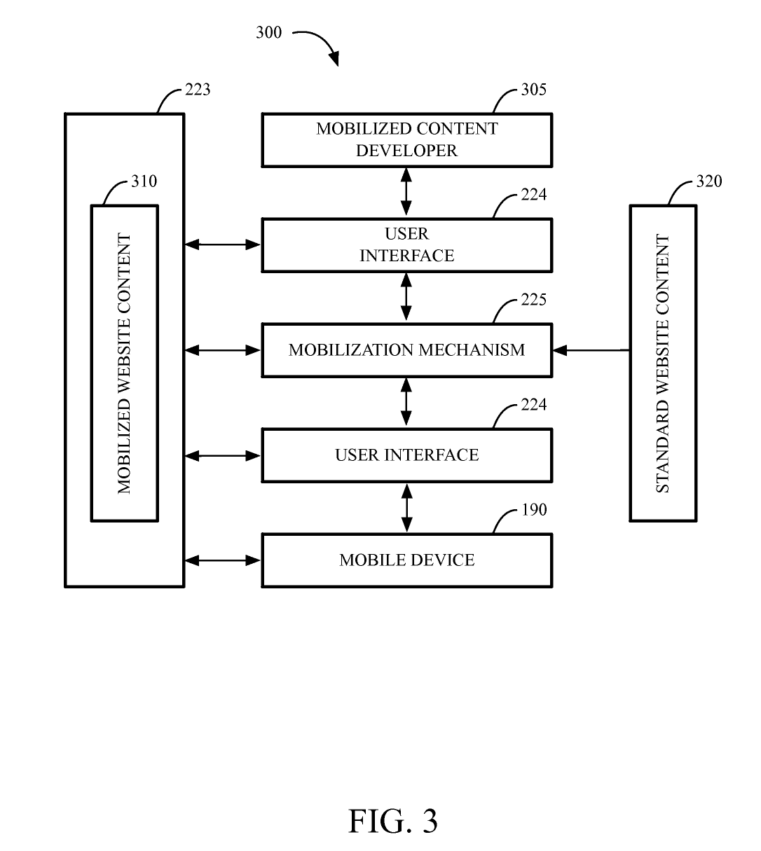

Referring now to FIG. 3, a block diagram 300 depicting the interactions of users with computer-based system 100 of FIG. 1 is depicted. As shown in FIG. 3, a mobilized content developer 305 will interact with user interface 224. By accessing user interface 224, mobilized content developer 305 can input and modify the data contained in database(s) 223, including accessing database 223 to store mobilized web content generated from standard website content 320. User interface 224 is configured to programmatically interact with mobilization mechanism 225 and database 223 of FIG. 2, specifically for the purpose of processing the standard website content 320 necessary to create mobilized website content for consumption by constituents using mobile device 190.

As shown in FIG. 3, mobilized content developer 305 can interact with mobilization mechanism 225 via user interface 224. Mobilized content developer 305 can configure one or more templates that will instruct mobilization mechanism 225 to extract a subset of standard website content 320 from one or more standard websites. Mobilization mechanism will also be configured to use the template(s) to transform the standard website content 320 into mobilized website content 310.

In operation, a user will access a customized application via mobile device 190 and request access to one or more websites via user interface 224, which is a user interface on mobile device 190. The request for access to the website (e.g., a URL) will be passed to mobilization mechanism 225. Mobilization mechanism 225 will first query database 223 to determine if the content for the requested standard website content 320 has been previously transformed into mobilized website content 310. If so, then the mobilized website content 310 will be served from database 223 to mobile device 190.

On the other hand, if the requested standard website content 320 identified by the user request has not yet been transformed into mobilized website content 310, mobilization mechanism 225 will obtain the requested standard website content 320 and transform the standard website content 320 into mobilized website content 310 using one or more previously created templates. The newly created mobilized website content 320 will be assigned a unique URL and will then be delivered to mobile device 190. Any newly created mobilized website content 310 will also be stored in database 223 so as to be available for any future requests for the same mobilized website content 310.

In at least some preferred embodiments of the present invention, mobilization mechanism 225 may also be configured to periodically “refresh” mobilized website content 310 by locating any updated standard website content 320 and transforming it into mobilized website content 310. The identification of new standard website content can be accomplished by accessing the date/time stamp for standard website content 320 and comparing it to the date/time stamp for any mobilized website content 310 previously created from the corresponding standard website content 320. This process may be automatically repeated at user-defined intervals (e.g., every 24 hours).

Alternatively, mobilized website content 310 may be created and updated on an “on demand” basis, whenever a user request is received. Further, mobilization mechanism 225 may receive a notification or alert whenever a change to standard website content 320 is made. Similarly, mobilization mechanism 225 may query the system and ask whether or not any changes to standard website content 320 have been made and, if so, a new version of mobilized website content 310 may be generated. Finally, it is also possible to simply identify a user-definable period of time which, if exceeded without any notification of changes to website content 320 have been made, a new version of mobilized website content 310 may be generated. It is anticipated that all of these methods may be used, depending on the application environment. Further, whenever a new version of mobilized website content 310 is generated, a date/time stamp identifying the time for the update may be generated and stored to use in additional processes.

Referring now to FIG. 3 and FIG. 4, an HTML template 400 used to transform standard website content 320 into mobilized website content 310 is depicted. Template 400 comprises a combination of a URL, HTML rules, CSS parameters, and other configuration information that is used to convert standard website content 320 to mobilized website content 310. As shown in FIG. 4, one or more subsets of the standard website content have been extracted from a standard website and inserted into template 400. Additionally, one or more sets of content mobilization instructions 420 have been included in template 400. Content mobilization instructions 420 are specifically designed to transform standard website content 320 to make it more suitable for display on mobile device 190. Content mobilization instructions 420 typically include font type and size designations, image reference pointers, etc.

In the most preferred embodiments of the present invention, a template 400 will be created for each URL to identify each web page that is to be converted from standard website content 320 to mobilized website content 310. Additionally, in at least one preferred embodiment of the present invention, anytime the initial configuration parameters of a template 400 are modified by mobilized content developer 305, mobilization mechanism 225 will access standard website content 320 and create updated mobilized content 310 for storage in database 223, using the modified parameters for the template 400. A custom URL will be created for mobilized website content 310, identifying it with the URL for the website from which the standard website content was extracted and this custom URL will generally remain fixed, regardless of changes to the underlying content in standardized website content 320. Additionally, mobilization mechanism 225 will create a custom icon to be displayed in user interface 224 of mobile device 190. Then, whenever a user wants to access the URL for standard website content 320, the user can click on the custom icon and the mobilized website content 310 will be displayed to the user.

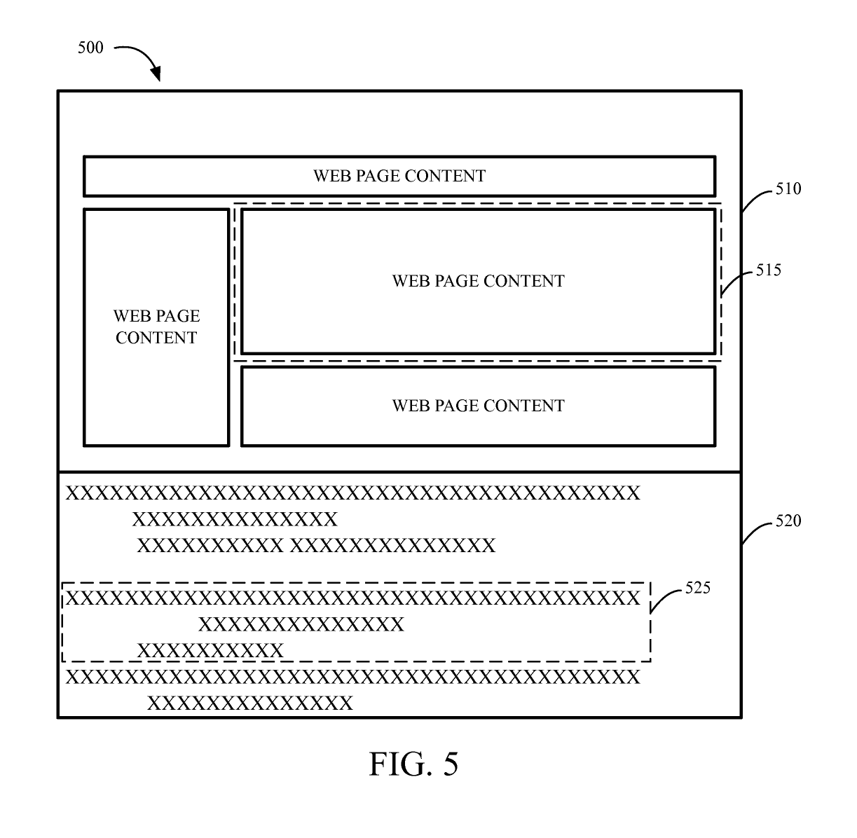

Referring now to FIG. 5, a schematic diagram representing the website content elements 510 displayed on a standard webpage 500, along with the computer code 520 used to generate webpage 500, is depicted. Using a web browser such as Google® Chrome®, it is possible to simultaneously display the website content elements 510 of a webpage and the computer code 520 used to generate website content elements 510. As shown in FIG. 5, the upper portion of a computer monitor displays webpage content 510 and the lower portion of the computer monitor displays computer code 520. Each website content element 510 is created by the execution of a portion of computer code 520. As each website content element 510 is selected (e.g., by using a mouse or other pointing device), the snippet of computer code 520 used to generate the selected website content element 510 is also highlighted. As shown in FIG. 5, website content element 515 is generated by computer code element 525.

In the most preferred embodiments of the present invention, the relevant subset of the standard website content displayed at webpage 500 that is to be transformed to mobilized content can be identified using the configuration parameters in a template 400. To the extent that a webpage uses standardized nomenclature and programming codes to create and identify website content elements 510, the process of extracting relevant website content elements 510 can be accomplished programmatically. Additionally, in at least some preferred embodiments of the present invention, where standardization is less than ideal, human intervention and discrimination may be used to manually select the desired website content elements 510 as well.

In general, since many webpages contain highly relevant and important information (e.g., place and time information, informative announcements, etc.) as well as less important information (e.g., advertisements, links to other pages, etc.), only the most relevant information is selected to be included in the mobilized website content. Once the relevant subset of the standard website content is identified, the specific snippets of computer code 520 used to create the relevant subset of the content can be identified. Once identified, the corresponding computer code can be copied and stored in database 223, along with a date/time stamp and a custom URL, and used to create the mobilized website content displayed at webpage 500. As previously explained, one or more templates 400 will be used to control the display of the website content items 510 selected for display on mobile device 190.

As shown in FIG. 5, a “mobilization filter” consists of a unique subset of computer code 520 terminating with the opening HTML tag of the desired subset 525 and containing any immediately preceding portion of computer code 520 required to make the mobilization filter uniquely identifiable by mobilization mechanism 225. For example, consider the following sample of actual computer code 520 (HTML).

```
<html>
<head>
  <title>A Standard Web Site</title>
  <link rel=“stylesheet” type=“text/css” href=“style.css” />
</head>
<body>
<div id=“header”>
  <h1>Page Header</h1>
</div>
<div id=“body”>
  <p> This set of tags identifies the content of interest.</p>
  <p> The content of interest contain content elements such as
images, tables, and hyperlinks.</p>
</div>
<div id=“footer”>
  <p>Page Footer</p>
</div>
</body>
</html>
```

In this example, the relevant subset 525 consists of the following:

```
<div id=“body”>
  <p>This set of tags identify the content of interest.</p>
  <p>The content of interest may contain content elements such as
images, tables, and hyperlinks.</p>
</div>
```

This subset may be identified by any unique subset of 520 that terminates with the opening tag of 525, such as:

```
<div id=“body”>
  <h1>Page Header</h1>
</div>
<div id=“body”>
<div id=“header”>
  <h1>Page Header</h1>
</div>
<div id=“body”>
<body>
<div id=“header”>
  <h1>Page Header</h1>
</div>
<div id=“body”>
```

All of the above subsets are unique subsets of computer code 520 and each may serve as the mobilization filter to identify the relevant subset 525 to mobilization mechanism 225.

In this instance, using the specific template example, the content of the <div id=“body”> tag may change at any time in the future and the desired content will be captured and transformed without requiring the mobilization filter to be updated. However, if the definition of the tag or any part of the mobilization filter changes, the mobilization filter may no longer identify a unique subset of standard website content 320 and would need to be modified. Accordingly, in general, mobilized content developer 305 will define the smallest unique subset to serve as mobilization filter. An optimal mobilization filter may comprise a single opening tag with a unique set of attributes that is unlikely to change when the contents of the webpage are updated. This will provide for a more robust template.

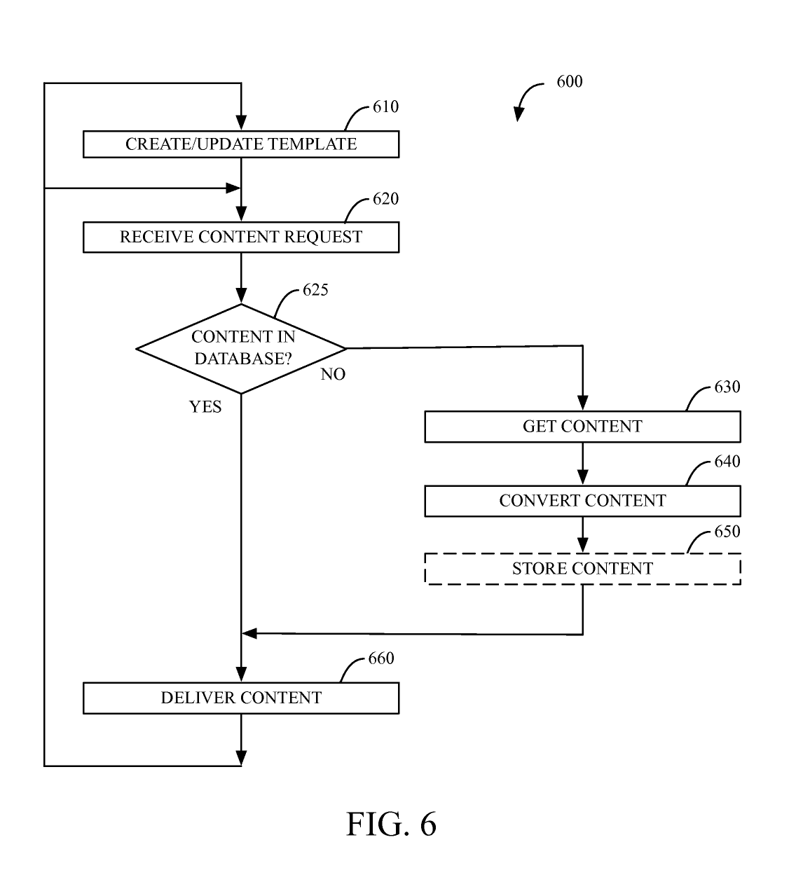

Referring now to FIG. 6, a flow chart for a method 600 of creating and serving mobilized website content from standard website content 320 is depicted. As shown in FIG. 6, mobilized content developer 305 will initially create a template (step 610). As previously explained, each template will be designed and customized for a specific URL and be configured to capture the most salient data from the URL specified in the template. When a request to deliver website content to mobile device 190 is received from the user of mobile device 190 (step 620) the mobilization mechanism will query the database to determine whether or not mobilized content for the requested URL is already available (step 625). If the mobilized website content has already been stored in the database (step 625=“YES”) then the mobilized website content will be delivered to the user's mobile device 190 (step 660).

On the other hand, if the mobilized website content has not already been stored in the database (step 625=“NO”) then mobilization mechanism 225 will get the most salient content from the standard website (step 630), convert a subset of standard website content 320 retrieved from the URL to mobilized website content 310 (step 640) and mobilized website content 310 will then be stored in the database (optional step 650) and be delivered to the user (step 660). After mobilized website content 310 has been delivered, another content request can be fulfilled in a similar manner. Additionally, one or more templates may be added or updated as necessary. For multiple pages containing content from the same standard website, it may be necessary to create multiple templates, but the mobilized website content 310 can be linked (e.g., with embedded hyperlinks) so that the functionality of accessing mobilized website content 310 will be as expected by the user, where clicking on a link will allow the user to access additional mobilized website content 310 pages.

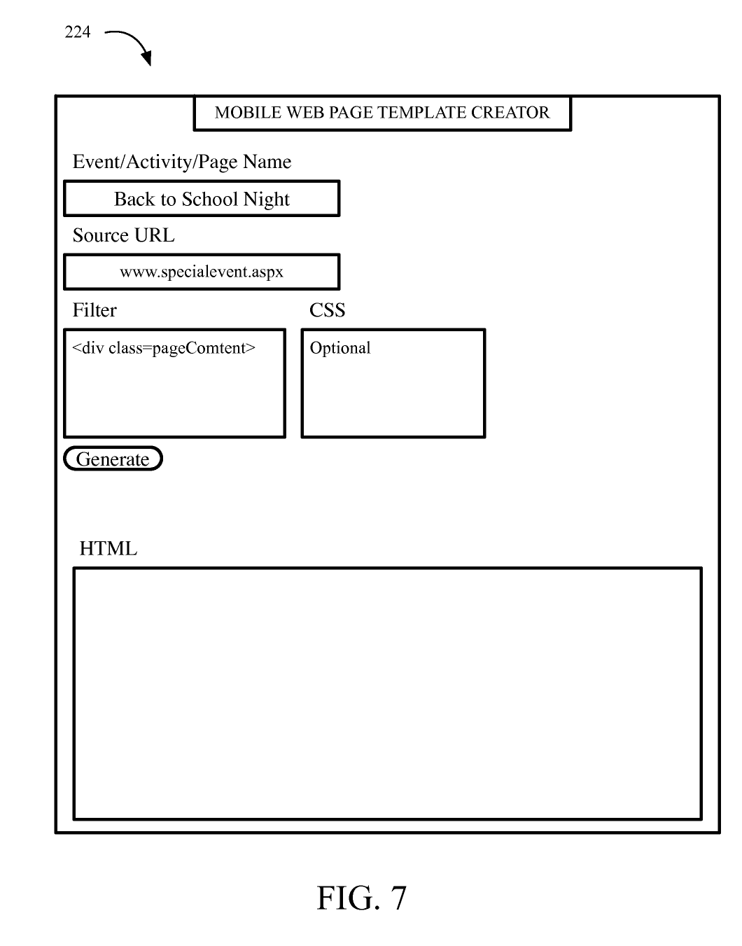

Referring now to FIG. 7, a user interface 224 for creating templates used to transform standard website content 320 into mobilized website content 310 is depicted. As shown in FIG. 7, mobilized website content developer 305 can specify the name for the event or activity or webpage that will be used to identify the mobilized website content generated by the sample template. Mobilized website content developer 305 will identify the source URL for the standard website content 320 and include one or more mobilization filters and/or CSS references to be used in identifying and transforming the content of interest located at the source URL. With the source URL and mobilization filter(s) identified, an HTML window will display the specific subset of the standard website content to be extracted from the source URL.

Once all of the desired parameters have been finalized and the desired content of interest has been correctly identified in the HTML window, mobilized website content developer 305 will simply press the “generate” button and the mobilized website content 310 will be created, along with a custom icon to represent the specified activity or event. As previously explained, mobilized website content can then be stored for later retrieval and/or served to a mobile device for viewing by a user.

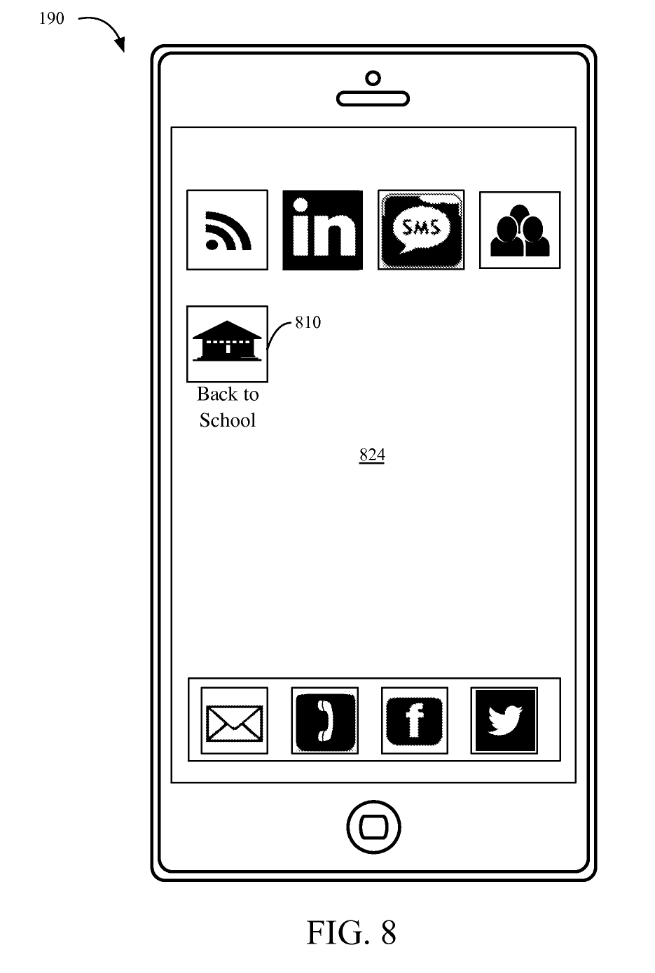

Referring now to FIG. 8, a user interface 824 associated with mobile device 190 for accessing mobilized web site content 310 is depicted. User interface 824 is representative of many smart phone interfaces inasmuch as the user interacts with a series of icons to perform various tasks and access various functions. In FIG. 8, icon 810 represents a webpage for a back to school night generated by the template of FIG. 7. The user can select icon 810 to gain access to mobilized website content 310. When the user clicks on icon 810, mobilized website content 310 is served from database 223, if mobilized website content has been previously developed or, alternatively, mobilization mechanism 225 will create mobilized website content 310 from the standard website content associated with the template that has been configured in conjunction with icon 810. It is important to note that multiple icons 810 may be displayed in conjunction with user interface 824, with each icon 810 being linked to a unique mobilized website content collection.

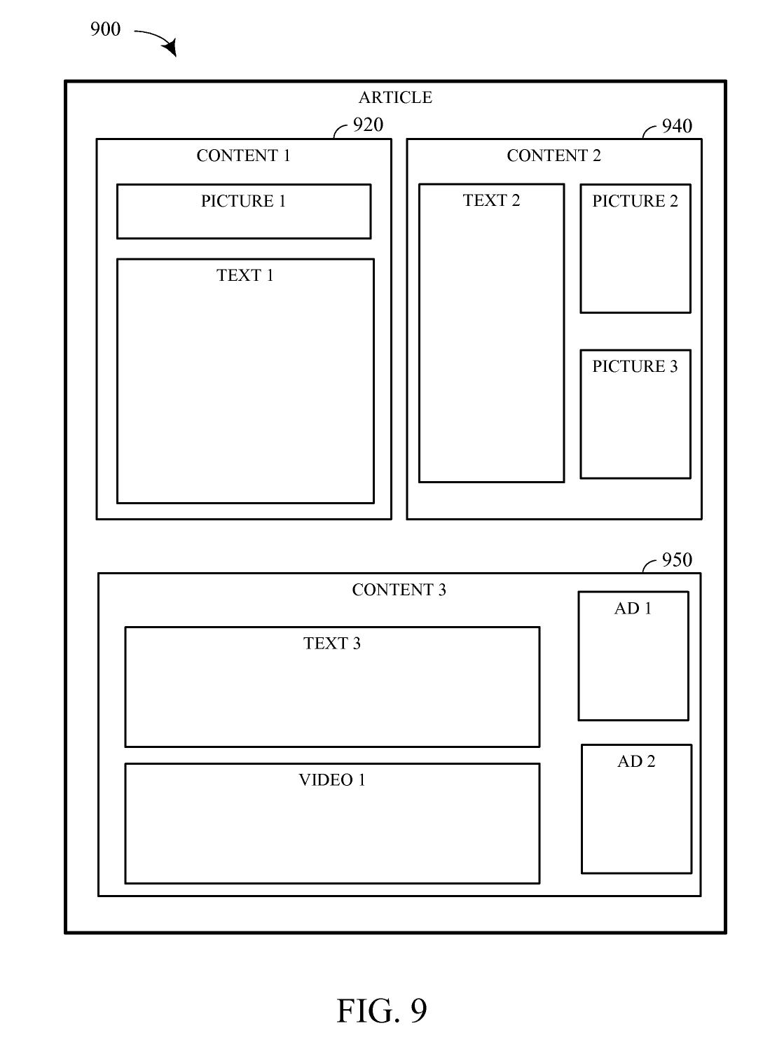

Referring now to FIG. 9, a schematic representation of a webpage containing standard website content 900 used to create mobilized website content in accordance with a preferred exemplary embodiment of the present invention is depicted. While it is possible to include a wide variety of content in mobilized website content, in certain circumstances, it is often desirable to omit or alter certain portions of the original standard website content 900. As shown in FIG. 9, standard website content 900 represents a typical website that may comprise various content items, including text, pictures, video, advertisements, etc.

Based on the needs of the consumers of the mobilized website content to be created from standard website content 900, one or more of the content items may be programmatically omitted from the final mobilized website content. For example, in order to keep the amount of information at a more manageable level, all picture content items (e.g., items tagged as .jpg, .png, etc.) may be automatically excluded from the final mobilized website content displayed to the user of mobile communication device 190 of FIG. 1.

Similarly, hypertext markup language (“HTML”) headers, tags or other content identifiers may also be used to identify and specifically include and/or screen out certain types of content items, while including desired content items. Certain content items associated with pre-determined identifiers and meta tags may be marked for inclusion or exclusion and those content items will be included or excluded in the resulting final mobilized website content. Additionally, the actual size and shape of the content item may also be used to determine which content is properly included or excluded from final mobilized website content. For example, banner advertisements typically include graphical elements that are three or four times wider than they are tall. So, by using this information, content items with a width to height ratio outside of certain parameters may be programmatically excluded from final mobilized website content. For example, a template may be created where any content item that has greater than a 3-1 width to height ratio will be programmatically excluded from the final mobilized website content by invoking a properly configured template.

In at least one preferred embodiment of the present invention, computer-based system 100 of FIG. 1 “scrapes” content from various websites, including newspaper websites to create mobilized website content. Those skilled in the art will recognize that content creators such as newspaper publishers often publish advertisements next to the articles. Consequently, providing a way to gather the relevant content without also capturing and introducing advertisements into the final mobilized website content is usually a desirable outcome. In order to achieve this result, one or more templates may be configured to programmatically use one or more of the following methods to provide only the relevant content: ignoring ads; verifying article image(s); and finding the text of the relevant article(s) on the webpage. The most preferred embodiments of the present invention will use all three methods to most efficiently harvest only the most relevant and appropriate information.

For example, a template may contain one or more mobilization filters that will begin by searching keywords in the HTML content for the website and ignore any section of the HTML content that has a “class” with the following key words: ‘combx’, ‘comment’, ‘com’, ‘contact’, ‘foot’, ‘footer’, ‘footnote’, ‘header’, ‘instagram’, ‘inline-ad’, ‘masthead’, ‘media’, ‘meta’, ‘outbrain’, ‘promo’, ‘related’, ‘scroll’, ‘shoutbox’, ‘singleAd’, ‘sidebar’, ‘sponsor’, ‘shopping’, ‘tags’, ‘tool’, ‘widget’, ‘advertisement’, ‘subscribe’, ‘popular’, ‘ad_{—}300’, or ‘ad’.

Similarly, certain website content may be programmatically identified by a template with a keyword-based mobilization filter for identifying content for inclusion in the final mobilized website content by computer-based system 100. For example, by searching keywords in the HTML content for the website and locating any section of the HTML content that has a “class” with the following key words: ‘article’, ‘story’, ‘entry’, ‘hentry’, ‘content’, ‘art_’, ‘post-content’, ‘gallery’, ‘asset-body’, ‘mainContent’, ‘main’, ‘featured’, meaningful content can be extracted for inclusion in the final mobilized website content.

Computer-based system 100 may also be configured with a template and one or more mobilization filters to programmatically ignore any graphic image or picture file that has a height to width ratio that is less than 1:4 (generally indicating a banner ad) and greater than 5:2 (generally indicating a column ad) and select content items for inclusion in the final mobilized website content that are not advertisements, based on this programmatic editing controlled by a template. The final mobilized website content may also contain manually selected and edited content items as well as programmatically selected and edited content items.

Finally, one or more templates may be configured with a mobilization filter to programmatically locate the picture file with the largest area that has a height to width ratio that is greater than 1:4 and less than 5:2 and transmit this file for inclusion in the final mobilized website content and also find the text that is associated with that picture file. To find the associated text, the template may be programmed to search for “div classes” with the following “article” keywords: ‘article’, ‘story’, ‘entry’, ‘hentry’, ‘content’, ‘art_’, ‘post-content’. If no “class” with a relevant article keyword is found, then computer-based system 100 will locate the text box that has the largest area, is adjacent to the “picture file with the largest area”, even if it does not have the desired keywords. Computer-based system 100 will then transmit this text for display in the final mobilized website content adjacent to the picture file with the largest area that was downloaded.

Similarly, in the case of sending final mobilized website content that is targeted for delivery to a feature phone (e.g., not a smart phone) that is incapable of handling video files, the final mobilized website content generated from standard website content 900 may omit video 1 from the final mobilized website content.

This, and other techniques to create templates that produce mobilized website content may be accomplished via user interface 224 of FIG. 2 or a graphical user interface accessible via mobile communication device 190 of FIG. 1. The person creating the templates can specify which content is included and which content is excluded from the mobilized website content derived from standard website content 900. Based on the selected parameters, video segments, advertisements, etc. can all be automatically excluded.

As will be appreciated by one skilled in the art, aspects of the computer-based system disclosed herein may be embodied as a system, method or computer program product. Accordingly, aspects of the computer-based system may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the computer-based system may take the form of a computer program product embodied in one or more computer readable medium(s) having computer readable program code embodied thereon.

Any combination of one or more computer readable medium(s) may be utilized The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the computer-based system may be written in any combination of one or more programming languages, including an object oriented programming language such as Objective-C, Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

From the foregoing description, it should be appreciated that computer-based system 100 and method for customized messaging disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A computer-based system for optimizing content for mobile devices comprising:
at least one processor;
at least one memory coupled to the at least one processor;
a database residing in the at least one memory;
a mobilization mechanism residing in the at least one memory;
at least one template residing in the at least one memory, the at least one template defining at least one mobilization filter being configured to transform standard website content into mobilized website content; and
a plurality of content for at least one mobilized website, the plurality of content for the at least one mobilized website being generated by the mobilization mechanism and the at least one template.

2. The computer-based system of claim 1 wherein the plurality of content for the at least one mobilized website is displayed on at least one mobile device.

3. The computer-based system of claim 1 further comprising a user interface, wherein at least one user interacts with the user interface to create the at least one template by:
specifying a source URL for the standard website content; and
specifying the at least one mobilization filter for generating the mobilized website content from the standard website content identified by the source URL.

4. The computer-based system of claim 1 further comprising a customized icon generated by the at least one template, wherein the customized icon is displayed on the at least one mobile device and provides access to the mobilized website content.

5. The computer-based system of claim 1 wherein the at least one mobilization filter is configured to programmatically extract a subset of the standard website content based on a height to width ratio for at least one graphic image.

6. The computer-based system of claim 1 wherein the mobilized content is stored in the memory and delivered to the at least one mobile device based upon a request from the at least one mobile device.

7. The computer-based system of claim 1 wherein the mobilized website content is stored in the at least one memory and automatically re-generated and updated based on at least one pre-determined schedule.

8. The computer-based system of claim 1 wherein the mobilized website content is initially generated and delivered in response to a request received from the at least one mobile device.

9. The computer-based system of claim 1 wherein the mobilized website content comprises a subset of the standard website content and wherein the at least one template comprises a plurality of filters that have been configured to extract the subset of the standard website content based on a height to width ratio for at least one graphic image and optimize the standard website content for display on the at least one mobile device.

10. The computer-based system of claim 1 further comprising a user interface, wherein:
the at least one user interacts with the user interface to create the at least one template in order to optimize website content by:
specifying a source URL for the standard website content; and
generating the mobilized website content from the standard website content identified by the source URL, wherein the mobilized website content comprises a subset of the standard website content and wherein the at least one template comprises a plurality of filters that have been configured to programmatically extract the subset of the standard website content based on a height to width ratio for at least one graphic image and wherein the standard website content is optimized for display on the at least one mobile device and wherein the mobilized content is stored in the memory and automatically re-generated and updated based on a pre-determined schedule; and
a customized icon is generated by the at least one template, wherein the customized icon is displayed on the at least one mobile device thereby providing access to the mobilized website content.

11. A method for providing optimized content to mobile devices comprising the steps of:
extracting a subset of content displayed by at least one standard website;
applying at least one template to the subset of content, the at least one template containing at least one mobilization filter;
transforming the subset of content into a mobilized version of the subset of content, the mobilized version of the subset of content being configured to display at least one mobilized website; and
saving the mobilized version of the subset of content to at least one memory.

12. The method of claim 11 wherein the step of applying the at least one template containing the at least one mobilization filter to the subset of content further configures the at least one mobilized version of the subset of content for display on at least one mobile device.

13. The method of claim 11 further comprising the step of interacting with a user interface displayed by a computer-based system and configuring the at least one template via the user interface by:
specifying a source URL for the at least one standard website; and
selecting the at least one mobilization filter for generating the mobilized version of the subset of content displayed at the at least one standard website identified by the source URL.

14. The method of claim 11 further comprising the step of displaying a customized icon on at least one mobile device, the customized icon providing access to the at least one mobilized version of the subset of content.

15. The method of claim 11 wherein the step of extracting a subset of content displayed by at least one standard website comprises the step of using the at least one mobilization filter to programmatically extract the subset of the standard website content based on a height to width ratio for at least one graphic image.

16. The method of claim 11 further comprising the steps of:
storing the at least one mobilized version of the subset of content in at least one memory; and
delivering the subset of the content to at least one mobile device based upon a request from the at least one mobile device.

17. The method of claim 11 further comprising the steps of:
storing the mobilized version of the subset of content in at least one memory; and
automatically regenerating and updating the mobilized version of the subset of content stored in the at least one memory based on a pre-determined schedule.

18. The method of claim 11 further comprising the step of creating and delivering the at least one mobilized version of the subset of content to at least one mobile device in response to a request received from the at least one mobile device.

19. The method of claim 11 wherein the at least one template comprises a plurality of HTML filters that have been configured to optimize the subset of content for display on at least one mobile device.

20. The method of claim 11 further comprising the step of interacting with a user interface configured for at least one user to create the at least one template in order to optimize website content by:
specifying a source URL for the content of the at least one standard website;
generating the at least one mobilized version of content from the standard website identified by the source URL, wherein the at least one mobilized version of the content comprises at least a subset of the standard website content and wherein the at least one template comprises a plurality of HTML filters that have been configured to extract the subset of the standard website content and optimize the subset of the standard website content for display on at least one mobile device;
storing the at least one mobilized version of the content in the at least one memory of the computer-based system and automatically re-generating and updating the at least one mobilized version of the content based on a pre-determined schedule;
generating at least one customized icon; and
providing access to the at least one mobilized version of content by displaying the customized icon on the at least one mobile device.
